(19) United States
(12) Patent Application Publication
(10) Pub. No.: US 2011/0176704 A1
(43) Pub. Date: Jul. 21, 2011

(54) Optical Character Recognition Lottery verification tool

(76) Inventor: Brian Marranzini, (US)

(21) Appl. No.: 12/688,923

(22) Filed: Jan. 18, 2010

(51) Int. Cl. G06K 9/20

(52) U.S. Cl. 382/100; 382/321

(57) ABSTRACT

An interactive rapid response system that utilizes optical character recognition through digital imaging of paper based lottery tickets and rapidly checks against internet based sources to see if they are winners. The system is designed to work on mobile devices, handheld devices, and computers.

### TECHNICAL FIELD AND APPLICABILITY OF THE INVENTION

A consumer based system related to the quick verification of lottery tickets for information purposes.

### BACKGROUND OF THE INVENTION

Lottery tickets consisting of a selection of numbers are sold throughout the world in various formats usually consisting of a series of numbers either manually selected by individual purchasers or automatically randomly generated selections by the point of sale terminal. Formerly the process of checking to see if a consumer had a winning ticket was a manual and time consuming effort, this invention will assist by allowing an individual to take a digital picture of their tickets and using optical character recognition compare the results against online sources to see if there is a potential match.

What is claimed is:

1. A cell phone, PDA mobile device, scanner or digital camera is used to capture the image of the lottery ticket.

2. That image is analyzed through software to abstract the individual numbers and characters off of the ticket.

3. The analyzed data is then compared against online sources for preliminary verification of potential winning tickets.
